(19) United States
(12) Patent Application Publication
(10) Pub. No.: US 2019/0118578 A1
(43) Pub. Date: Apr. 25, 2019

(54) RUNNER PIN FOR A ROLLER

(71) Applicant: GROSS + FROELICH GMBH & CO., Weil der Stadt (DE)

(72) Inventors: Ralph Von Bordelius, Herrenberg (DE); Oswald Flik, Althengstett (DE)

(21) Appl. No.: 16/220,844

(22) Filed: Dec. 14, 2018

Related U.S. Application Data
(63) Continuation of application No. 12/735,480, filed on Jul. 19, 2010.

(30) Foreign Application Priority Data
Feb. 1, 2008 (DE) 10 2008 007 445.4

(51) Int. Cl. B60B 33/00

(52) U.S. Cl. CPC B60B 33/0002; Y10T 16/18; B60B 33/001; B60B 33/0021

(57) ABSTRACT

The invention relates to a roller, in particular furniture roller, having a housing which is rotatably fastened, by means of a runner pin arranged vertically in an opening of the housing, to an object to be supported by the roller, wherein the runner pin has a first section which is arranged in the opening of the housing and a second section which projects beyond the housing. To create, in a simple and cost-effective manner, a runner pin which permanently prevents an undesired generation of noise as a result of relative movements between the runner pin and the object to be supported, it is proposed according to the invention that at least two annular grooves are provided in that section of the runner pin which projects beyond the housing, in which annular grooves in each case one elastic retaining ring is arranged without play.

### RELATED APPLICATIONS

The present application is a continuation of U.S. Ser. No. 12/735,480, filed Jul. 19, 2010, which is a § 371 national stage application of PCT International Application No. PCT/EP2008/066116, filed Nov. 25, 2008, which application claims a right of priority to German Application No. 10 2008 007 445.5, filed on Feb. 1, 2008. All of the foregoing applications are hereby incorporated by reference.

### TECHNICAL FIELD

The invention relates to a roller, in particular a furniture roller, having a housing, which is rotatably fastened, by means of a runner pin arranged perpendicularly in an opening of the housing, to an object to be supported by the roller, wherein the runner pin has a first section, which is arranged in the opening of the housing, and a second section, which projects beyond the housing.

### BACKGROUND

Rollers of the type stated are fastened by means of that section of the runner pin which projects beyond the housing in a blind hole in the object to be supported, e.g. a chair spider of an office chair. For this purpose, that section of the runner pin which projects beyond the housing has an annular groove, in which a resilient retaining ring with a slightly larger diameter than the blind hole is arranged. That section of the runner pin which projects beyond the housing is inserted into the. blind hole, with the retaining ring being compressed radially and the roller being held nonpositively on the object. However, the retaining ring has a certain axial and radial play relative to the annular groove in the runner pin. If an office chair, for example, is now rolled over a floor that has irregularities, such as a tiled floor, the runner pin can move up and down and execute a tumbling motion in the blind hole, within the limits of the available play. This leads to troublesome bell-like noise generation. EP-A-1 527 905 has disclosed a roller, the runner pin of which for this reason clamps a retaining ring in a play-free manner in a groove formed by a shoulder in the pin and a plastic bush mounted on the end of the pin in a location opposite the shoulder. Both the play-free retaining ring and the plastic bush are intended to eliminate unwanted noise generation. However, on the one hand the production of a runner pin of this kind is quite an involved process and, on the other hand, the plastic bush is subject to a certain wear after some time, with the result that the retaining ring no longer fits without play in the groove and the runner pin has play once more in the blind hole.

### BRIEF SUMMARY

Taking this situation as a starting point, it is the underlying object of the present invention to make available a roller with a runner pin which can be produced in a simple manner and inserted in a permanently play-free manner in a blind hole in an object to be supported.

To achieve this object, the combination specified in patent claim 1 is proposed. Advantageous embodiments and developments of the invention will become apparent from the dependent claims.

The invention starts especially from the realization that a ring-in-groove solution is the most economical option for a practical releasable connection between the roller and the object to be supported. In order to permanently eliminate axial and radial movements of the runner pin in the blind hole, the proposal according to the invention is therefore that at least two mutually spaced annular grooves should be provided in that section of the runner pin which projects beyond the housing, in each of which annular grooves an elastic retaining ring is arranged without play. The use of two mutually spaced retaining rings prevents a tumbling motion of the runner pin in the blind hole while the play-free arrangement of the retaining rings prevents an axial motion. To achieve effective support, one groove is arranged in the upper third and the at least one further groove is arranged in the lower third of that section of the runner pin which projects beyond the housing. If there are more than two grooves, it is advantageous if these are arranged approximately at equal distances from one another and from the ends of the section.

In order to achieve freedom from play of the retaining ring in its groove, the elastic retaining ring can be an open spring snap ring made of steel or plastic or an 0 ring made of rubber or some other elastomer. Since it would be a comparatively involved procedure to match the width of the groove, i.e. the axial spacing between the groove flanks, and the wire diameter of a flat spring snap ring made of steel to one another with such accuracy that freedom from play would be achieved, the width of the groove in a preferred embodiment of the invention is greater than the wire diameter of the open spring snap ring, and the latter is designed as a spring in both the axial and radial directions and is supported by end sections on the facing flanks of the annular groove.

To allow radial installation of the spring snap ring, it is expedient if said ring has a circumferential extent of 250° to 300°, preferably about 270°. It is then a simple matter to snap it into the groove from the side. If the retaining ring is a continuous 0 ring made of rubber or some other suitable elastomer, it is pushed axially over the end of the runner pin into the corresponding groove.

In order to keep the installation and removal force within the existing limits, it is expedient if the two retaining rings have a lower elastic force, preferably about half the elastic force, of the retaining rings previously used. This can be achieved, for example, through a reduced wire thickness, e.g. a wire thickness of 1.2 mm instead of the previous 1.5 mm.

### BRIEF DESCRIPTION OF THE DRAWINGS

The invention is explained in greater detail below by means of the illustrative embodiments depicted schematically in the drawing. In the drawing:

FIG. 1 shows a runner pin for a roller having two retaining rings; and

FIG. 2 shows two perspective views of the retaining rings shown in FIG. 1.

### DETAILED DESCRIPTION OF THE DRAWINGS AND THE PRESENTLY PREFERRED EMBODIMENTS

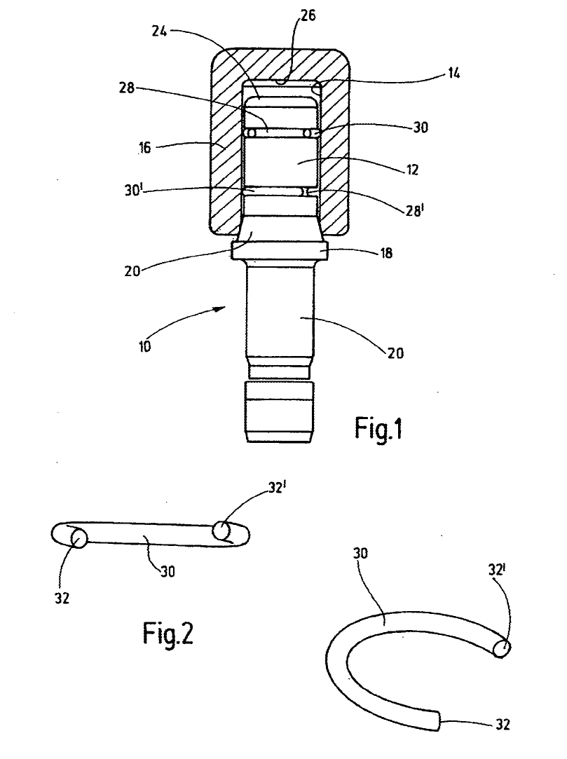

The runner pin 10 depicted in FIG. 1, which belongs to a roller (not shown) of a well-known type, is arranged with one section 12 in a blind hole 14 in an object 16 to be supported by the roller, e.g. the spider base of an office chair. Section 12 of the runner pin 10 extends as far as a collar 18 approximately in the center of the pin and is the section which projects beyond the housing of the roller, while the other section 20 of the pin is inserted in such a way into a vertically aligned opening in the roller housing that the housing can rotate about section 20. Directly adjoining the collar 18 section 12 has a supporting cone 20, which serves as a stop for the rim of the blind hole 14 and limits the axial penetration of section 12 into the blind hole 14, ensuring that there is a spacing of a few millimeters remaining between the end 24 of section 12 and the bottom 26 of the blind hole 14.

Section 12 has two grooves 28, 28′, in each of which a retaining ring 30, 30′ (FIG. 2) designed as an open spring snap ring is arranged. The grooves 28, 28′ are arranged spaced apart, approximately in the upper and lower third of section 12. The retaining rings 30, 30′ are made by bending a spring wire in such a way that they act both as axial and as radial springs. The axial extent of the retaining rings 30, 30′ when relaxed is greater than the spacings between the flanks of the grooves 28, 28′, with the result that, after insertion into the grooves, the rings are clamped in the grooves by their open ends 32, 32′ In this way, any axial play of the retaining rings 30, 30′ in the grooves 28, 28′ is eliminated. The radial spring force of the retaining rings 30, 30′ is brought to bear when the runner pin 10 is inserted into the blind hole 14 and ensures that there is a radially play-free nonpositive engagement between the retaining rings 30, 30′ and the inner wall of the blind hole 14. As a result, the runner pin 10 has neither axial nor radial play in the blind hole 14. It is thus impossible for troublesome noise to be generated during travel over uneven floors.

Instead of the retaining rings 30, 30′ depicted in FIG. 2, it is also possible for correspondingly designed plastic rings or 0 rings made of rubber or some other elastomer to be used, either in pairs or in combination with one another, i.e. a retaining ring 30 in one groove 28, 28′ can be combined with an 0 ring in the other groove, for example.

In summary, it may be stated that: the invention relates to a roller, in particular a furniture roller, having a housing, which is rotatably fastened, by means of a runner pin 10 arranged perpendicularly in an opening of the housing, to an object 16 to be supported by the roller, wherein the runner pin 10 has a first section 20, which is arranged in the opening of the housing, and a second section 12, which projects beyond the housing. In order, in a simple and economical manner, to provide a runner pin which permanently prevents troublesome noise generation due to relative motion between the runner pin and the object to be supported, the proposal according to the invention is that at least two mutually spaced annular grooves 28, 28′ should be provided in that section 12 of the runner pin 10 which projects beyond the housing, in each of which annular grooves an elastic retaining ring 30, 30′ is arranged without play.

1. A roller for an object, comprising:
a roller housing; and
a runner pin arranged perpendicularly in an opening of the housing, wherein the runner pin has a first section which is arranged in the opening of the housing, and a second section which projects beyond the housing for attachment to the object, wherein at least two mutually spaced annular grooves are provided in the second section of the runner pin; and
at least two elastic retaining rings arranged without axial play in the at least two annular grooves;
wherein the roller has a detached configuration wherein the second section is not attached to the object, the at least two elastic retaining rings arranged in the at least two annular grooves in the detached configuration.

2. The roller as claimed in claim 1, wherein the grooves have a depth sized to receive a thickness of the retaining rings.

3. The roller as claimed in claim 1, wherein the elastic retaining rings are open spring snap rings made of steel or plastic or an O-ring made of rubber or some other elastomer.

4. The roller as claimed in claim 3, wherein the retaining rings are designed as open spring snap rings made of steel is supported by end sections on facing flanks of the annular groove.

5. The roller as claimed in claim 3, wherein the spring snap rings each have a circumferential extent of 250° to 300°, preferably 270°.

6. The roller as claimed in claim 3, wherein free ends of each snap ring are axially spaced such that each snap ring acts as both axial and radial springs.

7. The roller as claimed in claim 3, wherein each snap ring is made of wire having a wire thickness of 1.2 mm.

8. An object-caster combination comprising:
an object to be supported, the object having a blind hole with a smooth wall surface and a bottom surface, the smooth wall surface circumferentially surrounding an opening of the blind hole, the bottom surface located opposite the opening; and
a caster supporting the object, the caster having a housing which is rotationally fastened to the object by a caster stem arranged perpendicularly in an opening of the housing, the caster stem having a first section which is arranged in the opening of the housing, and a second section which projects beyond the housing and into the blind hole of the object;
the second section of the caster stem having a first annular groove provided in an upper third thereof and second annular groove provided in a lower third thereof, the annular grooves being arranged at approximately equal distances from one another and from the ends of the second section; and
in each of the annular grooves, an elastic retaining ring is arranged without axial play for engaging with the smooth wall surface of the object's blind hole, wherein each elastic retaining ring is pre-positioned in its respective annular groove before insertion of the second section of the caster stem into the blind hole of the object, wherein each elastic retaining ring is sized to be compressed when inserted into the blind hole of the object;
wherein the second section includes a supporting cone that is sized and positioned to partially pass through the opening of the blind hole in the object and engage the opening to limit axial penetration of the second section and control a position of the annular grooves and elastic retaining rings within the blind hole.

9. The object-caster combination as claimed in claim 8, wherein the caster engages the object at three axially spaced locations, the first location being at the opening of the blind hole where the supporting cone engages the object, the second location being within the blind hole where a first ring of the retaining rings engages the smooth wall surface of the blind hole of the object, and the third location being further within the blind hole where a second ring of the retaining rings engages the smooth wall surface of the blind hole of the object.

10. The object-caster combination as claimed in claim 8, wherein the position of the annular groves and elastic retaining rings is controlled such that there is a spacing between an end of the second section and a bottom of the blind hole.

11. The object-caster combination as claimed in claim 8, wherein the elastic retaining ring is an open spring snap ring made of steel or plastic or an O-ring made of rubber or some other elastomer.

12. The object-caster combination as claimed in claim 11, wherein the retaining ring is an open spring snap ring made of steel and is supported by end sections in the annular groove.

13. The object-caster combination as claimed in claim 11, wherein the spring snap ring has a circumferential extent of 250° to 300°.

14. The object-caster combination as claimed in claim 8, wherein the object is a piece of furniture.

15. An object-caster combination comprising:
an object to be supported, the object having a blind hole with a smooth wall surface and a bottom surface, the smooth wall surface circumferentially surrounding an opening of the blind hole, the bottom surface located opposite the opening; and
a caster supporting the object, the caster having a housing which is rotationally fastened to the object by a caster stem arranged perpendicularly in an opening of the housing, the caster stem having a first section which is arranged in the opening of the housing, and a second section which projects beyond the housing and into the blind hole of the object;
the second section of the caster stem further includes a supporting cone that is sized and positioned to partially pass through the opening of the blind hole in the object
the second section of the caster stem having first and second annular grooves unitarily formed in the caster stem, the second annular groove axially spaced from the first annular groove; and
first and second elastic retaining rings arranged in the first and second annular grooves respectively, the first and second elastic retaining rings structured to act as both axial and radial springs, wherein each elastic retaining ring is sized to be radially compressed when inserted into the blind hole of the object;
wherein the caster engages the object at three axially spaced locations,
the first location being at the opening of the blind hole where the supporting cone engages the object,
the second location being within the blind hole where a first ring of the retaining rings engages the smooth wall surface of the blind hole of the object, and
the third location being further within the blind hole where a second ring of the retaining rings engages the smooth wall surface of the blind hole of the object.

16. The object-caster combination as claimed in claim 15, wherein the first and second annular grooves are arranged at approximately equal distances from one another and from the ends of the second section.

17. The object-caster combination as claimed in claim 15, wherein the first annular groove is provided in an upper third of the second section and the second annular groove is provided in a lower third thereof.

18. The object-caster combination as claimed in claim 15, wherein each elastic retaining ring is pre-positioned in its respective annular groove before insertion of the second section of the caster stem into the blind hole of the object.

19. The object-caster combination as claimed in claim 15, wherein the supporting cone is sized and positioned to engage the opening to limit axial penetration of the second section and leave a space between the caster stem and the bottom of the blind hole.
